(19) United States
(12) Patent Application Publication
(10) Pub. No.: US 2006/0006578 A1
(43) Pub. Date: Jan. 12, 2006

(54) VIAL WITH HINGED CAP AND METHOD OF MAKING SAME

(75) Inventors: Joseph E. Johnson, Woodstock, CT (US); Patrick J. Brannon, Warwick, RI (US); Clifford W. Skillin, Blackstone, MA (US)

Correspondence Address: BARLOW, JOSEPHS & HOLMES, LTD., 101 DYER STREET, 5TH FLOOR, PROVIDENCE, RI, 02903, US

(73) Assignee: POLYTOP CORPORATION, Slaterville, RI (US)

(21) Appl. No.: 11/160,675

(22) Filed: Jul. 5, 2005

Related U.S. Application Data
(60) Provisional application No. 60/587,276, filed on Jul. 12, 2004.

(51) Int. Cl. B29C 45/00

(52) U.S. Cl. 264/242; 264/348; 264/328.1

(57) ABSTRACT

A method of making a dispensing vial from a plastic material. The vial includes a vial body, a vial lid and a living hinge structure connecting the vial lid to the vial body. The dispensing vial is molded and removed from the mold still warm. The living hinge structure is flexed while the plastic is still warm. Thereafter, the sealing surfaces are actively cooled to cause the plastic to fully set, and finally the vial lid is closed shut.

### CROSS-REFERENCE TO RELATED APPLICATION

This application is related to and claims priority from earlier filed U.S. Provisional Application No. 60/587,276, filed Jul. 12, 2004, the contents of which are incorporated herein by reference.

### BACKGROUND OF THE INVENTION

1. Field of the Invention

The present invention relates to containers and vials having hinged closures that maintain a seal. More specifically, the present invention relates to a vial having an integrally hinged cap and a method for manufacturing the vial.

2. Background of the Related Art

Containers and vials having hinged closures are well known in the art. In this regard, there are dozens of patents that describe various different configurations of dispensing closures and vials with hinged caps, as well as different methods for manufacturing such products. The U.S. patents to Hayberg, U.S. Pat. No. 4,351,630; Wilson et al, U.S. Pat. No. 4,220,248; Hazzard, U.S. Pat. No. 4,377,247; Eitzinger, U.S. Pat. No. 4,847,988; and Wilson, U.S. Pat. No. 5,271,536 are just a few examples of the art in this area. As can be seen from many of the drawing figures in these patents, dispensing closures and vials generally include a main body and hinged lid integrally formed with and connected to the main body by a living hinge. The main body typically includes an “orifice” for dispensing of the product, while the lid usually includes a “spud” which is received in friction fit into the orifice to form a seal and prevent unwanted dispensing of the product. The one-piece assembly is obviously molded in the open position, and then closed in a subsequent processing operation. Because many of the dispensing closures are used on liquid beauty products, such as shampoo, and food products, such as ketchup and syrups, a leak-proof seal must be formed at the “spud” and “orifice” of the closure.

In the area of manufacturing there is also a significant body of prior art for automated molding and closing of dispensing closures. As early as 1983 many companies began using automation apparatus for the handling and closure of dispensing closures after molding. For example, several early closure machines were based upon a rotary table closure system that included a vibratory feed (see U.S. Pat. No. 4,847,988). Molded parts were dropped out of the mold onto a conveyor that in turn dumped into the vibratory feed bowl. The vibratory feed oriented the loose parts and fed them to a processing line that in turn fed into a multi-station continuous motion, rotating table. As each part was fed onto the table and rotated to the next position, the lid of the closure would be successively lifted up and over until finally rotated to the fully closed position. These rotary table processing machines are still actively in use today in manufacturing facilities. As early as 1984, manufacturers also began experimenting with automated closing processes using part removal robots.

In the past, it was also well accepted that the best way to conform sealing surfaces for the best sealing characteristics was to mate the sealing surfaces together shortly after molding while the plastic material was still somewhat warm, i.e. not fully set. In the context of plastic materials intended for use in everyday life, “fully set” should be understood to mean that the material has returned to an ambient “normal use” temperature.

In the molding of plastic closures, the plastic material is injected molded at a temperature of about 420° F.-430° F. After molding, the material must be cooled in the mold to about 100° F.-120° F., at which temperature the plastic is cool enough so as not to deform upon removal from the mold, but yet is still above ambient temperature and warm enough to still provide some conforming shrinkage or “set” as it continues to cool down to room temperature. It is thus common knowledge that the dispensing closures should be closed shortly after removal from the mold to provide a “better” seal at the contact of the spud and orifice.

This teaching is clearly identified in several U.S. patents from the 1970's through the early 1990's. For example, in the U.S. patent to Hayberg, U.S. Pat. No. 4,351,630 (1982), the inventors identified the importance of exercising the living hinge soon after molding (still in the mold) (See column 1, lines 37-50). Hayberg also recognized the importance of closing of the lid shortly after closing to insure a good seal (See column 1 lines 50-64.)

The U.S. patent to Eitzinger U.S. Pat. No. 4,847,988 (1989) also recognized the importance of closing the lid shortly after molding (See column 3, lines 24-32).

Turning back to the vial configuration of the present invention, the vials and dispensing closures described hereinabove were, until recently, predominantly used for storing and dispensing liquid products. However, there has been a recent trend in the candy industry to develop unique dispensing packages for small candy products, such as sugar-coated chocolates, and other sugar-based candies.

In this regard, several candy manufacturers have adopted the use of a vial with a hinged closure for the sale and dispensing of such sugar-based candy products. Please refer to U.S. Pat. No. 5,133,470 (Abrams), U.S. Pat. No. 4,807,425 (Abrams), and U.S. Pat. No. 4,783,056 (Abrams) for an example of one such vial (cylindrical in shape) currently used in the candy industry.

Dispensing vials with a hinged cap provide a simple configuration for filling and sealing of the product during manufacture, and further provide the end consumer with the ability to open and close the package multiple times. While the existing vial configurations are effective for their intended purpose, there is a perceived need in the industry for additional vial configurations which will allow candy manufactures to distinguish their product from others with different shaped vials and cap designs.

However, there are unique environmental issues that must be addressed in the packaging of food products, and in particular sugar-based candy products. Sugar based candies pose a particular problem in that the container must have an adequate seal to prevent the infiltration of moisture into the interior of the vial. Sugar based candy must remain isolated from significant amounts of moisture or the candies will become soft and will stick together.

Accordingly, the vial must have a certain minimum level of sealing capability to prevent the unwanted infiltration of air and moisture and for the candy to have an acceptable shelf life.

### SUMMARY OF THE INVENTION

The dispensing vial of the present invention includes a unique oval body with an open top and a lid integrally connected to the body by a living hinge structure. The body and cap are substantially oval in shape having a short linear side and arcuate front and rear surfaces. The upper lip of the body defines the “orifice” and includes an inner sealing bead and an outer sealing bead, the outer sealing bead being slightly larger than the inner sealing bead. The lid is formed with a complementary U-shaped sealing channel that is configured and arranged to be received over the lip in sealed relation when the lid is rotated about the living hinge to a closed position. The outer wall of the channel is provided with a sealing shoulder that is snap received over the outer sealing bead. The inner wall of the channel forms the “spud” which is received into the inside of the lip of the vial.

The body and lid are configured to mate and seal along two (2) separate engagement lines. The upper lip of the vial is not received entirely into the channel leaving a small gap above the upper edge of the lip. The first sealing engagement occurs at the contact of the inner sealing bead against the inner wall of the channel. The second sealing engagement occurs at the contact of the outer sealing bead and the outer wall.

In use, when the lid is closed onto the body, the U-shaped channel snaps over the sealing bead. The channel walls initially deflect outwardly to ride over the sealing beads, but then squeeze inwardly to provide a sealing force of the wall against the sealing beads and shoulder.

The manufacturing process for making the vial is also unique because of its unique oval shape and the configuration of the elongated U-shaped sealing channel. In the past, it was well accepted that the best way to conform sealing surfaces for the best sealing characteristics was to mate the sealing surfaces together shortly after molding while the plastic material was still somewhat warm, i.e. not fully set. Despite the well-known advantages of sealing a cap onto a body while the plastic is still warm, the present vial configuration did not perform as expected (did not have a sufficient seal) when closed immediately after molding.

The Applicants have speculated that the sealing configuration of the present oval vial behaved differently than a cylindrical vial and more specifically that the flexible channel walls in the lid were being flexed outwardly and permanently deformed during seating of the lid on the body (if the plastic was too warm). Thus, that the channel walls were thus not providing the proper compressive force to maintain a good seal. It was thereafter determined that an extended set-up (cooling) time prior to closing the cap provided the required sealing characteristics. Ultimately, this led the Applicants to the inventive manufacturing process wherein the sealing surfaces of the vials are cooled to a temperature below ambient temperature (<60° F.) upon removal from the mold and then closed while the plastic is still cold (fully set).

### BRIEF DESCRIPTION OF THE DRAWINGS FIGURES

These and other features, aspects, and advantages of the present invention will become better understood with regard to the following description, appended claims, and accompanying drawings where:

FIG. 1 shows front plan view of the vial of a version of the present invention;

FIG. 2 shows a top view thereof;

FIG. 2a shows a close-up view of the lid thereof;

FIG. 3 shows a bottom view thereof;

FIG. 4 shows a cross-sectional view thereof taken along line 4-4 of FIG. 2;

FIG. 5 shows a cross-sectional view thereof taken along line 5-5 of FIG. 2;

FIG. 6 shows a cross-sectional view thereof taken along line 6-6 of FIG. 2;

FIG. 7 shows an enlarged cross-sectional view of the snap bead detail circled in FIG. 6;

FIG. 8 shows an enlarged cross-section view of the lid detail circled in FIG. 6;

FIG. 8a shows an enlarged cross-section view of the lid along line 8a-8a of FIG. 2a;

FIG. 9 shows an enlarged cross-sectional view of the vial bead detail circled in FIG. 5;

FIG. 10 shows an enlarged cross-sectional view of the cap received onto the vial rim in a closed position;

FIG. 11 shows a top plan view of the robotic end of arm tooling used to hold and move the vials during manufacturing;

FIG. 12 shows a side view thereof showing the vials being ejected off of the molding tool into the nest cavities of the end of arm tooling;

FIGS. 13A-D shows plan views of the processing line where the vial lids are initially flexed and then fully closed while cold while traversing through a series of processing zones;

FIG. 14A shows a side view of the vial lid being flexed;

FIG. 14B shows a side view of the dispensing vial being cooled by blown refrigerated air;

FIG. 14C shows the final close of the vial lid against the vial body; and

FIG. 15 shows a graph illustrating sealing characteristics compared to time before closing the lid onto the vial.

### DETAILED DESCRIPTION OF THE PREFERRED EMBODIMENTS

A. The Vial

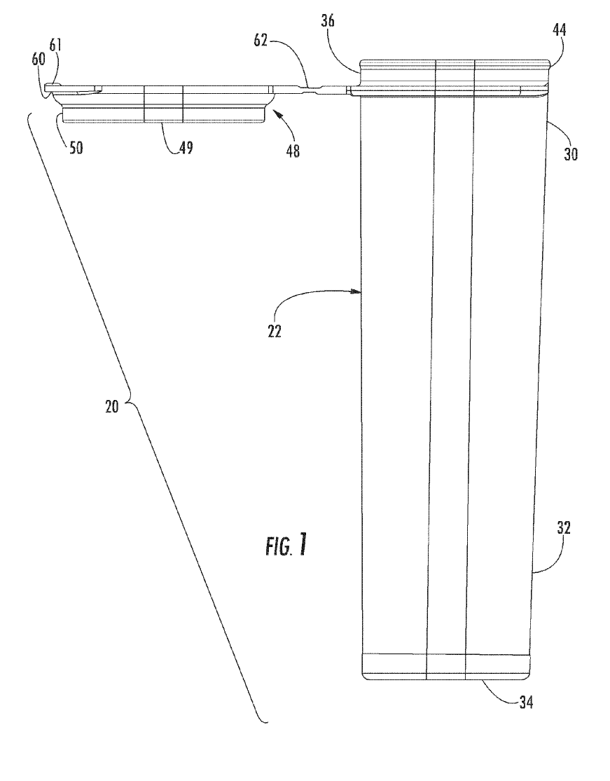

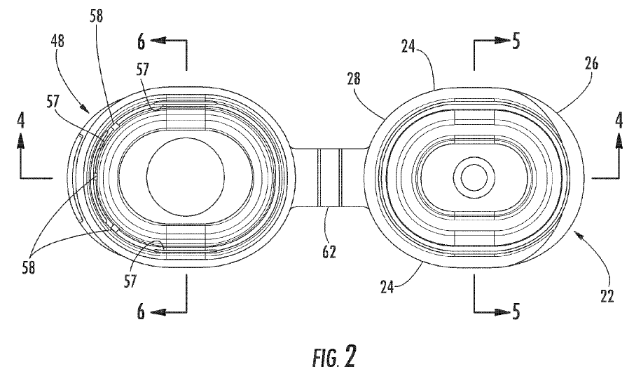

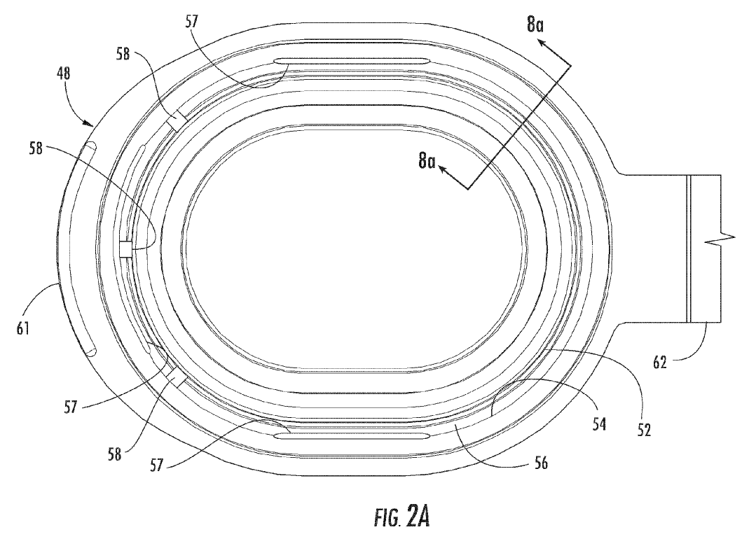

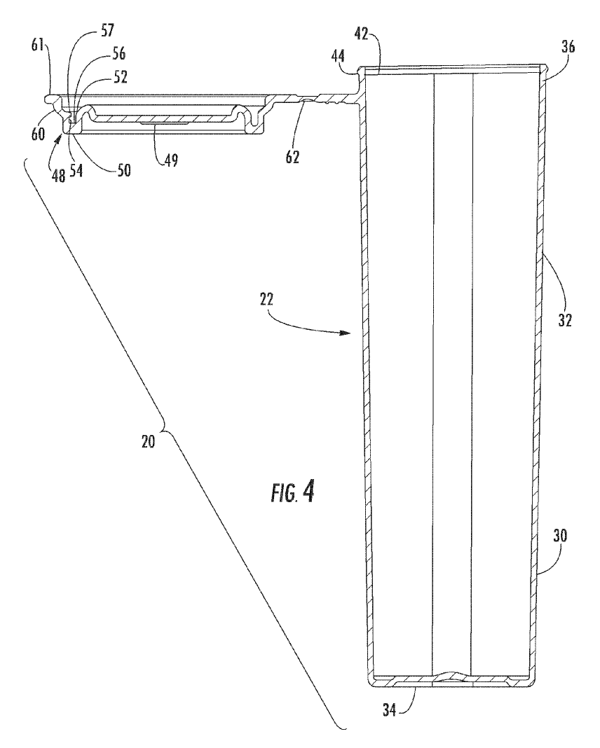

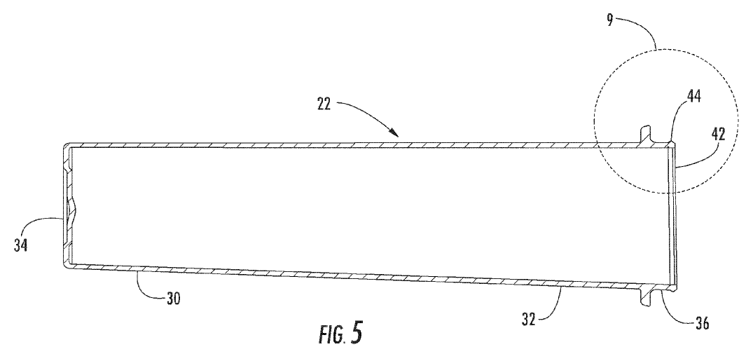

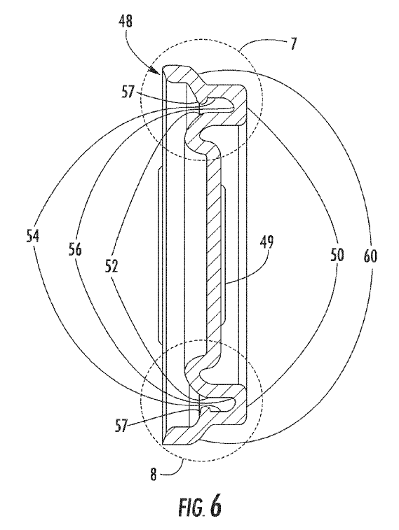

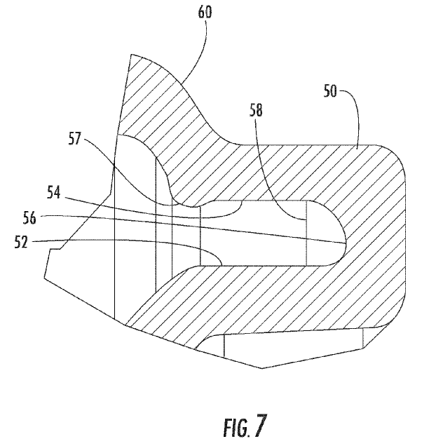

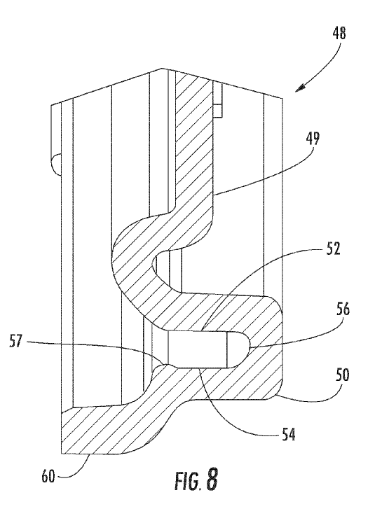

Referring to FIGS. 1-10, the dispensing vial of the present invention, shown generally at 20, includes a vial body 22 with an dispensing orifice 46 and a vial lid 48 integrally connected to the vial body 22 by a living hinge structure 62. The vial body 22 and vial lid 48 are substantially oval or elliptical in shape having a short linear side 24 and arcuate front surface 26 and an arcuate rear surface 28 (See FIGS. 2 and 3 for oval shape). Although the preferred embodiment of the present invention has an oval shape cross-section, the present invention can be applied to other vial geometries, such as square, circular or triangular to name a few, and the present invention should not be limited as such.

In many ways, the dispensing vial 20 is identical to that of a dispensing closure (not shown). The main exception being that the lower body portion 30 of the dispensing vial 20 is closed by a bottom surface 34, while the skirt (not shown) of the dispensing closure is open so that it can be threaded onto a container (not shown). In all other ways, the dispensing vial 20 is similar to the dispensing closure.

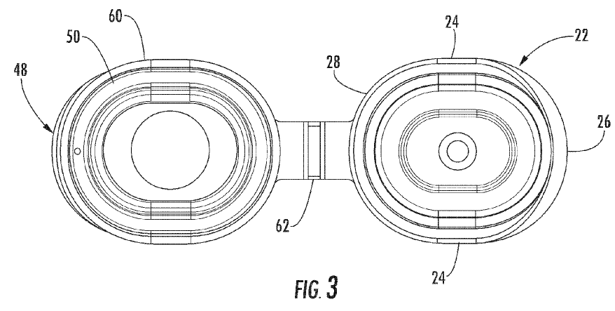

The upper lip 36 of the vial body 22 defines the dispensing orifice 46 and includes an inner annular sealing bead 42 and an outer annular sealing bead 44, the outer annular sealing bead 44 being slightly larger than the inner annular sealing bead 42 (See FIGS. 1, 4, 5, 9 and 10). The vial lid 48 is formed with a complementary U-shaped sealing channel 50, depending from a top portion 49, that is configured and arranged to be received over the upper lip 36 in sealed relation when the vial lid 48 is rotated about the living hinge structure 62 to a closed position (See FIGS. 4, 6, 7, 8 and 10).

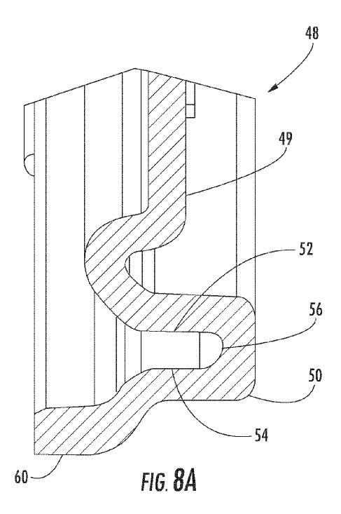

The outer annular sealing wall 44 of the U-shaped sealing channel 50 is provided with a snap rim 60 that is snap received over the outer annular sealing bead 44 (See FIGS. 2 and 10). An optional thumb catch 61 to assist the consumer in opening the vial lid 48 may be located on the snap rim 60. Referring to FIG. 2, the outer annular sealing wall 44 is actually provided with three separate snap beads 57 that provide the lid with an audible and tactile snap when the lid is closed. These snap beads 57 can best be seen in FIG. 2a.

The U-shaped sealing channel 50 of the vial lid 48 is further provided with three separate stop ribs 58 that project downwardly from the upper wall 56 of the U-shaped sealing channel 50 to maintain the gap at the top of the U-shaped sealing channel 50 and prevent the vial lid 48 from being closed too far. The inner annular sealing wall 42 of the U-shaped sealing channel 40 effectively forms a “spud” that is received into the inside of the upper lip 36 of the vial body 22.

The vial body 22 and vial lid 48 are configured to mate and seal along two (2) separate engagement lines identified in FIG. 2 as 4-4 and 5-5. The upper lip 36 of the vial body 22 is not received entirely into the U-shaped sealing channel 50 leaving a small gap (See FIG. 10) above the upper edge of the upper lip 36. The first sealing engagement occurs at the contact of the inner annular sealing bead 52 against the inner annular sealing wall 52 of the U-shaped sealing channel 50. The second sealing engagement occurs at the contact of the outer annular sealing bead 44 and the outer annular sealing wall 54. (Please note that FIG. 10 does not show the actual deflected positions of the annular sealing walls 42, 44 and that the drawings are intended for the purpose of illustrating the position of the sealing lines.)

In use, when the vial lid 48 is closed onto the vial body 22, the U-shaped sealing channel 50 snaps over the outer annular sealing bead 44. The annular sealing walls 52, 54 initially deflect outwardly (See arrow in FIG. 10) to ride over the outer annular sealing bead 44 and inner annular sealing bead 42, but then squeeze inwardly to provide a sealing force of the annular sealing walls 52, 54 against the annular sealing beads 42, 44.

B. The Manufacturing Process

I. General Discussion of Methodology

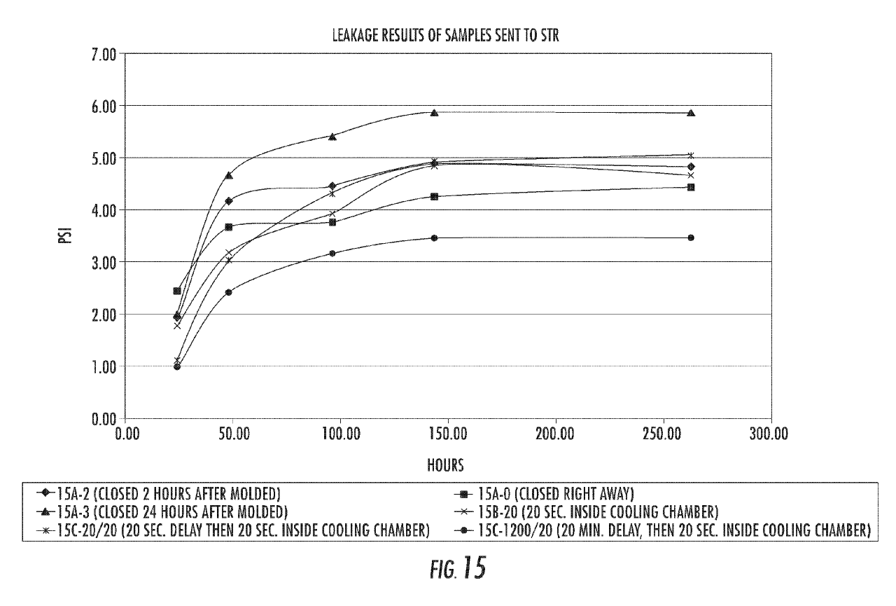

Despite the well-known advantages of sealing the cap onto the body while the plastic is still warm, the vials of the present invention did not perform as expected (did not have a sufficient seal) when closed immediately after molding. After repeated testing with the same results, the Applicants speculated that the sealing configuration of the oval vial behaved differently than a cylindrical vial. The forces would naturally be uneven around the peripheral edge. In the process of development, the vials were molded and then allowed to set up for various periods of time. A chart of the various testing scenarios is attached as FIG. 15.

Surprisingly, the longer the vials were allowed to stand before closure, the better the final seal. Please refer to the yellow line (triangle symbol 15A-3) in FIG. 15 representing the best sealing characteristics were obtained if the vials were allowed to sit for 24 hours. This testing led the Applicants to further speculate that the sealing walls in the lid were being flexed outwardly and permanently deformed during seating of the lid on the vial (if the plastic was too warm) and that the sealing walls were thus not providing the proper compressive force to maintain a good seal. The change in manufacturing criteria is thus believed to be a direct result of the physical design of the vial and lid.

While the extended set-up (cooling) time provided the required sealing characteristics, it was determined that it would not be feasible from a mass manufacturing perspective to mold the dispensing vials, let them sit for 24 hours and then close them.

Ultimately, this led the Applicants to its proposed manufacturing process wherein the sealing walls of the lid and vial are actively cooled to a temperature below ambient temperature (<60° F.) upon removal from the mold and then closed while the plastic is still cold (fully set). The specific details of the proposed manufacturing process are outlined in the preferred process described below.

II. Detailed Discussion of Manufacturing Steps

This invention envisions the use of an injection mold press (not shown) to produce the dispensing vials. In this embodiment, an injection mold press with a capacity for twenty-four (24) units was utilized, but other configurations would be equally as effective.

In the first step, the dispensing vials 20 are injection molded in the injection mold press. The vial body 22 and vial lid 48 are integrally molded together, connected by a living hinge structure 62. At the time of molding, the vial lid 48 and upper 36 are disposed in the same plane, or in other words are disposed in a position of 180° open.

Second, the mold halves are separated (not shown). The vial body 22 and vial lid 48 are retained on the post half of the mold 163 by retaining the outer annular sealing bead 44 on the upper lip 36 within its molding channel (not shown).

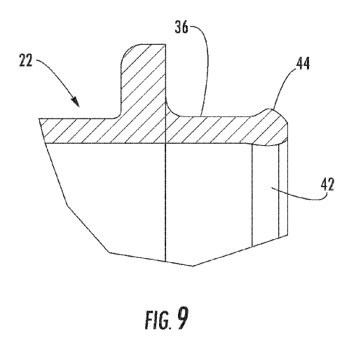

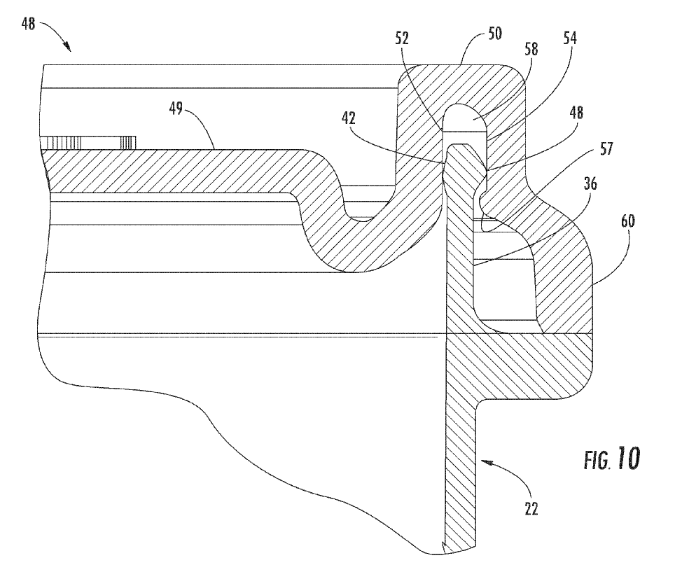

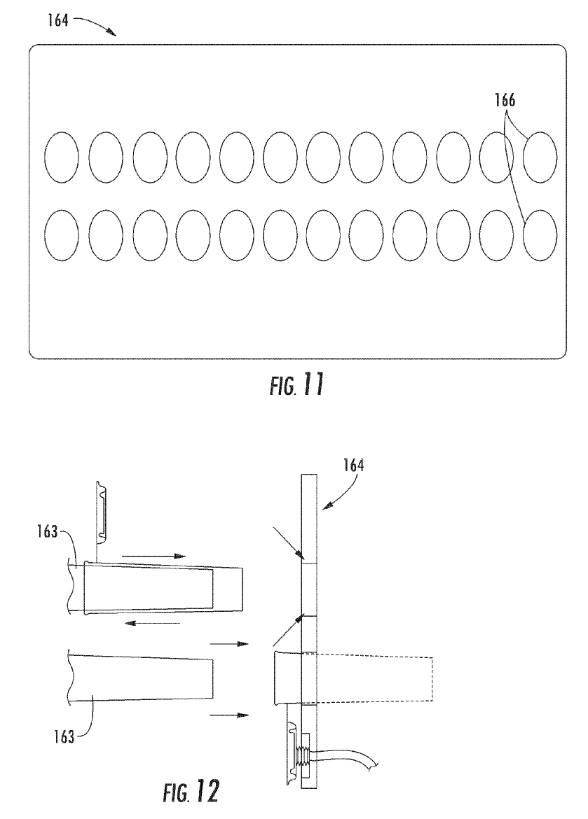

A robotic arm (not shown) descends into mold apparatus between mold halves. The robotic arm includes an End of Arm Tool (EOAT) 164 provided with nest cavities 166 for receiving the freshly molded dispensing vials 20 (See FIGS. 11 and 12). The dispensing vials 20 are completely ejected from the mold posts 163 into the nest cavities 166 on the EOAT 164 using compressed air. More specifically, the vial body 22 is moved forward on the mold post 163 as air jets feed air into vial body at the end of mold post. A mechanical stripper (not shown) initiates complete ejection. Compression builds until the force is sufficient to strip the outer annular sealing bead 44 from the mold channel. The dispensing vial 20 then shoots off the end of the most post 163 into a nest cavity 166 on the EOAT 164.

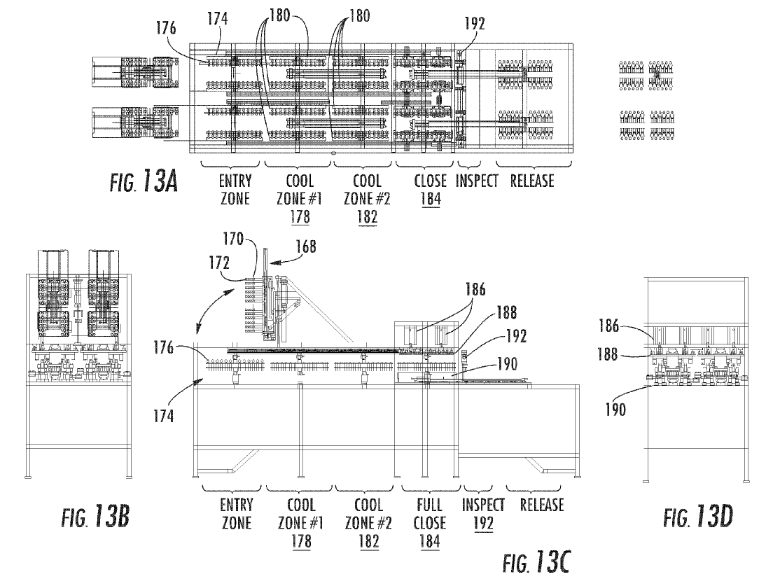

Thereafter, the robotic arm ascends out of the mold apparatus and traverses to a hand-off tool 168. (See FIGS. 13A-D). The hand-off tool 168 includes posts 170 to receive the dispensing vials 20. The dispensing vials 20 are placed onto posts 170 of the hand-off tool 168. The dispensing vials 20 are held in place by vacuum ports 172 on the posts 170. The robotic arm then returns to the injection mold press for next shot.

The hand-off tool 168 rotates 900 to place dispensing vials 20 in a transport shuttle 174 so they are oriented vertically for further processing. The transport shuttle 174 includes grippers 176 for holding the vial body 22 during processing.

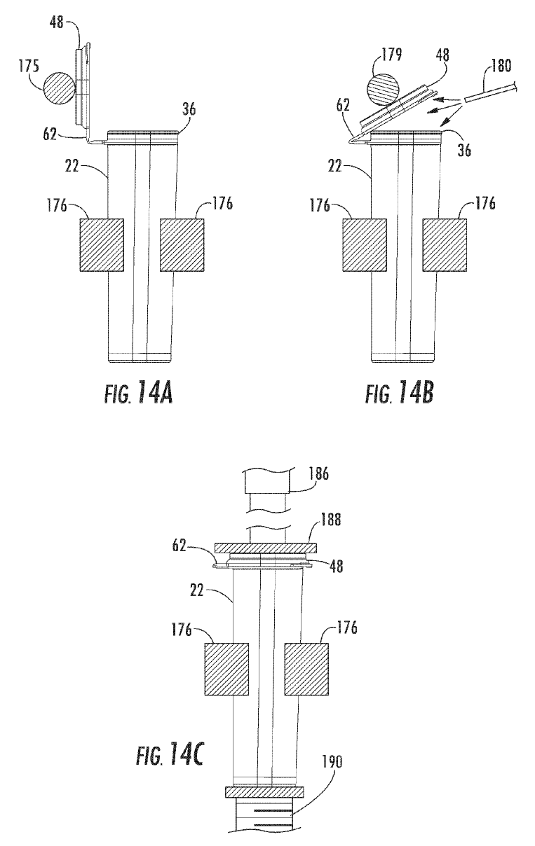

The vial lid 48 is moved upward by a first closing rod 175 to 90° when placed in transport shuttle to flex the living hinge structure 62 while the plastic is still warm. (See FIG. 14A). As identified in the prior art, it is still important to flex the living hinge structure while the plastic is still warm.

The transport shuttle 174 is indexed forward to an enclosed first cooling zone 178 where the vial lids 48 are further rotated by a second closing rod 179 to a position about 165° from its original molding position (almost closed or 15° open) so that the U-shaped sealing channel 50 and upper lip 36 are in close proximity, but not actually closed. The first cooling zone 178 is cooled with refrigerated compressed air to maintain a cooling zone temperature of about 56° F. at a dew point of about 43° F. and 55% relative humidity. The first cooling zone 178 also includes nozzles 180 that blow cold air directly onto the vial lid 48 and upper lip 36 of the vial body 22. For purposes of forming the seal, it is of primary importance that the plastic of the sealing structures at the vial lid and upper lip be cooled. The transport shuttle 174 remains in first cooling zone 178 for about 20 seconds. During this time the plastic material in the vial lid 48 and upper lip 36 of the vial body 22 are cooled to a temperature of less than 60° F., and more preferably to a temperature of about 56° F. (See FIGS. 13A-D, and 14B). The plastic could be cooled to even lower temperatures. However, for purposes of the present invention, and to speed manufacturing time, the specified temperatures are sufficient to achieve the required seal.

The transport shuttle 174 is then indexed forward to a second cooling zone 182, which is the same in construction as first cooling zone 178. The transport shuttle 174 remains in the second cooling zone 182 for about another 20 seconds. The cooling zones 178, 182 effectively age the dispensing vials 20 (and the sealing surfaces) equivalent to a set period of about 24 hours. With cooling to less than 60° F., the plastic is effectively in its “fully set” state as it would be found during normal use. (See FIGS. 13A-D, and 14B).

The transport shuttle 174 is indexed forward out of the second cooling zone 182 to a closing device 184. The temperature of the plastic material of the vial lid 48 and upper lip 36 of each vial 20 are measured (by infrared temperature sensors) outside of the second cooling zone 182 prior to full closure. As an optional step, any dispensing vial 20 not at or below 60° F. can be rejected if desired. The grippers 176 open and drop the vial 20 at this stage, before the final close. (See FIGS. 13A-D).

A closing device 184 then closes the vial lid 48 against the vial body 22 forming a complete peripheral seal. The dispensing vials 20 are supported on their bottom surfaces 34. Pneumatic cylinders 186 move the vials 20 upwardly and compress vial lids 48 against a top plate 188 where compression springs 190 exert an equal pressure downwardly for a full closure. It is important to note that the vial lids 48 are closed while the annular sealing walls 52, 54 and upper lip 36 of the vial body 22 are cool. (See FIGS. 13A-D, and 14C).

The transport shuttle 174 then moves to an inspection station 192 where the closure of vial lid 48 is confirmed. Properly closed dispensing vials 20 are released into bin (not shown). Defective dispensing vials 20 are sorted for reprocessing. The cooled dispensing vials 20 then return to room temperature in a closed state.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A method of making a dispensing vial from a plastic material, said method comprising the steps of:
molding the dispensing vial in a mold, said vial including a vial body, a vial lid, and a living hinge structure connecting the vial lid to the vial body, the vial lid being pivotably movable about the living hinge between an open and a closed position;
removing the dispensing vial from the mold;
cooling the plastic material to a fully set condition; and
moving the vial lid to a closed condition while the plastic material is in a fully set condition.

2. The method of claim 1 wherein the step of cooling comprises actively cooling the plastic material to a temperature of less than about 65° F.

3. The method of claim 2 wherein said temperature is about 60° F.

4. The method of claim 1 further comprising the step of flexing the living hinge structure after the step of removal from the mold but before the step of cooling and while the plastic material is still warm.

5. The method of claim 2 further comprising the step of flexing the living hinge structure after the step of removal from the mold but before the step of cooling and while the plastic material is still warm.

6. The method of claim 3 further comprising the step of flexing the living hinge structure after the step of removal from the mold but before the step of cooling and while the plastic material is still warm.

7. The method of claim 2 further comprising the step of allowing the plastic material to warm back to ambient temperature while the lid is in said closed position.

8. The method of claim 3 further comprising the step of allowing the plastic material to warm back to ambient temperature while the lid is in said closed position.

9. The method of claim 4 further comprising the step of allowing the plastic material to warm back to ambient temperature while the lid is in said closed position.

10. The method of claim 5 further comprising the step of allowing the plastic material to warm back to ambient temperature while the lid is in said closed position.

11. The method of claim 6 further comprising the step of allowing the plastic material to warm back to ambient temperature while the lid is in said closed position.

12. A method of making a dispensing vial from a plastic material, said method comprising the steps of:
molding the dispensing vial in a mold, said dispensing vial comprising a vial body having an upper lip forming a dispensing orifice, a vial lid, and a living hinge structure connecting the vial lid to the vial body,
the vial lid being pivotably moveable about the living hinge structure between an open and a closed position;
removing the dispensing vial from the mold;
flexing the living hinge structure while the vial is still warm;
cooling the plastic material via a cooling method;
closing the vial lid.

13. The method of claim 12 wherein the dispensing vial is removed from the mold by a robot.

14. The method of claim 12 wherein the cooling method causes the plastic material to fully set.

15. The method of claim 12 wherein the cooling method effectively ages the plastic material by about 24 hours.

16. The method of claim 12 wherein the cooling method comprises transporting said vial through a cooling zone having a temperature that is less than about 65° F.

17. The method of claim 16 wherein the cooling method comprises:
having a first cooling zone and a second cooling zone,
transporting the dispensing vial to the first cooling zone,
cooling the dispensing vial in the first the first cooling zone for a predetermined amount of time,
transporting the dispensing vial to the second cooling zone,
cooling the dispensing vial in the second cooling zone for a predetermined amount of time.

18. The method of claim 17 wherein the cooling method further comprises the additional steps of:
rotating the vial lid about the living hinge structure into an almost closed position at the first cooling zone,
cooling the dispensing vial by blowing cooled air onto the vial lid and upper lip of the dispensing vial,
repeating the above step at the second cooling zone.

19. The method of claim 16 wherein the cooling zone is cooled with refrigerated air to maintain a temperature of about 56° F. at a dew point of about 43° F. and about 55% relative humidity.

20. The method of claim 12 wherein the plastic material is cooled to at least 60° F. by the cooling method.

21. The method of claim 12 further comprising the steps of:
inspecting the dispensing vial for defects, and separating the dispensing vial if a detect is found.

22. The method of claim 21 further comprising the step of rejecting any dispensing vial that has not been sufficiently cooled.
